(19) United States
(12) Patent Application Publication
(10) Pub. No.: US 2014/0075491 A1
(43) Pub. Date: Mar. 13, 2014

(54) ERROR PROOF METHOD FOR RECORDING AND RECORDING DEVICE

(71) Applicants: Chu-Cheng HSU, New Taipei City (TW); Ssu-Ming CHENG, New Taipei City (TW); Chien-Ming YEH, New Taipei City (TW); Chao-Kai WANG, New Taipei City (TW)

(72) Inventors: Chu-Cheng HSU, New Taipei City (TW); Ssu-Ming CHENG, New Taipei City (TW); Chien-Ming YEH, New Taipei City (TW); Chao-Kai WANG, New Taipei City (TW)

(73) Assignee: AVERMEDIA TECHNOLOGIES, INC., NEW TAIPEI CITY (TW)

(21) Appl. No.: 13/612,882

(22) Filed: Sep. 13, 2012

(51) Int. Cl. H04N 21/433

(52) U.S. Cl. 725/153

(57) ABSTRACT

The method is applied to the recording device, and the recording device is connected to a set-top box. The error proof method includes following steps. In the beginning, whether a startup process of the set-top box has been finished is determined according to a video signal and an audio signal outputted from the set-top box. After the startup process of the set-top box is finished, the video signal outputted from the set-top box is analyzed to determine whether an image of the video signal is covered by an information window. If the image of the video signal is not covered by any information window, then a channel changing signal is transmitted to the set-top box, to change a channel of the set-top box to a reserved recording channel. After that, a television program of the reserved recording channel is recorded.

### BACKGROUND

1. Field of Invention

The invention relates to an error proof method and a device thereof. More particularly, the invention relates to an error proof method for recording and a recording device.

2. Description of Related Art

With the development of science and technology, television has already become an important part of people's life. People obtain information or get pleasure and satisfaction from a television program. Accordingly, in order to help people outdoors not miss their favorite television programs, a recording device has already become an indispensable household electronic product for people.

For the current conventional recording devices, their functions are only limited to simply implementing a predetermined flow. For example, a set-top box is started at a predetermined time, then a channel is changed after another predetermined time and a recording is started after a further predetermined time. Accordingly, the above-mentioned recording devices cannot make a response in real time according to a status of the set-top box, which may easily lead to recording failure or recording of an unexpected content.

In view of this, there is a need to provide a recording method applied to a recording device which can prevent recording failure.

### SUMMARY

An aspect of the invention provides an error proof method for recording which can be applied to a recording device connected to a set-top box. A video signal and an audio signal of the set-top box are analyzed to help the recording device record an expected television program correctly for users. According to an embodiment of the invention, the error proof method for recording includes the following steps: (a) whether a startup process of a set-top box has been finished is determined according to a video signal and an audio signal outputted from the set-top box; (b) after the startup process of the set-top box is finished, the video signal outputted from the set-top box is analyzed to determine whether an image of the video signal is covered by an information window; (c) if the image of the video signal is not covered by any information window, then a signal transmission component commanded to transmit a channel changing signal to change a channel of the set-top box to a reserved recording channel; and (d) after the channel of the set-top box is changed to the reserved recording channel, a recording is started and the recorded content is stored in a storage device.

According to another embodiment of the invention, the step (a) includes: determining whether the video signal outputted from the set-top box is received. If the video signal outputted from the set-top box is not received, then the signal transmission component is commanded to transmit a power source signal to start the set-top box.

According to still another embodiment of the invention, the step (a) further includes the following steps. After the power source signal is transmitted, whether the image of the video signal outputted from the set-top box includes a set-top box logo of the set-top box is analyzed. If the image of the video signal does not include the set-top box logo of the set-top box, then it is determined that the startup process of the set-top box is failed and the signal transmission component is commanded to restart the set-top box.

According to yet still another embodiment of the invention, the step (a) further includes the following steps. Whether the audio signal outputted from the set-top box is received is determined If the video signal is received while the audio signal is not received, then whether the image of the video signal is covered by the information window is determined. If the image of the video signal is covered by the information window, then the signal transmission component is commanded to transmit an information window eliminating signal to command the set-top box to eliminate the information window.

According to an embodiment of the invention, the error proof method for recording further includes: When the image of the video signal is covered by the information window, the signal transmission component is commanded to transmit the information window eliminating signal to command the set-top box to eliminate the information window.

According to another embodiment of the invention, the error proof method for recording further includes: after the channel of the set-top box is changed to the reserved recording channel, the video signal outputted from the set-top box is analyzed to determine whether the image of the video signal is covered by the information window, When the image of the video signal is covered by the information window, the signal transmission component is commanded to transmit the information window eliminating signal to command the set-top box to eliminate the information window

According to still another embodiment of the invention, the error proof method for recording further includes the following steps. An on-screen display (OSD) on the image of the video signal is analyzed to determine whether the channel changing signal is received correctly. If the channel changing signal is received incorrectly, then the signal transmission component is commanded to retransmit the channel changing signal to change the channel of the set-top box to the reserved recording channel.

According to yet still another embodiment of the invention, the error proof method for recording further includes the following steps. After the channel of the set-top box is changed, a channel logo on the image of the video signal is analyzed to determine whether the changed channel of the set-top box is the reserved recording channel. If the channel logo of the changed channel of the set-top box is different from that of the reserved recording channel, then the signal transmission component is commanded to retransmit the channel changing signal to change the channel of the set-top box to the reserved recording channel.

Another aspect of the invention provides a recording device which can record an expected television program correctly for users by analyzing a video signal and an audio signal outputted from a set-top box. According to an embodiment of the invention, the recording device includes a signal transmission component and a data processing component. The data processing component includes a startup determining module, an information window detecting module, a channel changing module and a recording module. The startup determining module is used to determine whether a startup process of a set-top box has been finished according to a video signal and an audio signal outputted from the set-top box. The information window detecting module is used to analyze the video signal outputted from the set-top box to determine whether an image of the video signal is covered by an information window after the startup process of the set-top box is finished. The channel changing module is used to command a signal transmission component to transmit a channel changing signal to change a channel of the set-top box to a reserved recording channel when the image of the video signal is not covered by any information window. The recording module is used to start a recording after the channel of the set-top box is changed to the reserved recording channel and is used to store the recorded content in a storage device.

According to another embodiment of the invention, the data processing component further includes an information window eliminating module. The information window eliminating module is used to command the signal transmission component to transmit an information window eliminating signal to eliminate the information window covering the image.

According to still another embodiment of the invention, the startup determining module includes a video signal determining unit and a set-top box startup unit. The video signal determining unit is used to determine whether the set-top box outputs the video signal. The set-top box startup unit is used to command the signal transmission component to transmit a power source signal to start the set-top box when the set-top box does not output the video signal.

According to yet still another embodiment of the invention, the startup determining module further includes a set-top box logo detecting unit and a set-top box restarting unit. The set-top box logo detecting unit is used to analyze whether the image of the video signal outputted from the set-top box includes a set-top box logo of the set-top box after the signal transmission component transmits the power source signal to the set-top box. The set-top box restarting unit is used to command the set-top box startup unit to restart the set-top box after the set-top box logo detecting unit determines that the image of the video signal does not include the set-top box logo of the set-top box.

According to an embodiment of the invention, the startup determining module further includes an audio signal analyzing unit and a command unit. The audio signal analyzing unit is used to determine whether the set-top box outputs the audio signal. The command unit is used to command the information window detecting module to determine whether the image of the video signal is covered by the information window when the set-top box outputs the video signal while it does not output the audio signal. If the image of the video signal is covered by the information window, then the information window eliminating module is notified to eliminate the information window covering the image.

According to another embodiment of the invention, the data processing component further includes an on-screen display analyzing module and a first retransmission module. The on-screen display analyzing module is used to analyze the on-screen display on the image of the video signal to determine whether the channel changing signal is received correctly. The first retransmission module is used to command the signal transmission component to retransmit the channel changing signal to change the channel of the set-top box to the reserved recording channel when the channel changing signal is received incorrectly.

According to still another embodiment of the invention, the data processing component further includes a channel logo analyzing module and a second retransmission module. The channel logo analyzing module is used to analyze a channel logo on the image of the video signal to determine whether the changed channel of the set-top box is the reserved recording channel after the channel of the set-top box is changed The second retransmission module is used to command the signal transmission component to retransmit the channel changing signal to change the channel of the set-top box to the reserved recording channel when the channel logo of the changed channel of the set-top box is different from that of the reserved recording channel.

In view of the above, the embodiments of the invention are applied to determine whether the startup process of the set-top box has been finished, whether the image outputted from the set-top box is covered by the information window, whether the channel changing signal is received correctly and whether the channel is changed to the reserved recording channel. Corresponding actions are made automatically through these determinations, which can make the recording device record the reserved television program correctly for users.

### BRIEF DESCRIPTION OF THE DRAWINGS

In order to make the foregoing as well as other aspects, features, advantages, and embodiments of the invention more apparent, the accompanying drawings are described as follows:

FIG. 1 illustrates a block diagram of a recording device according to an embodiment of the invention;

FIG. 2 illustrates a flow chart of an error proof method for recording according to an embodiment of the invention;

FIG. 3 illustrates a flow chart of partial details of an error proof method for recording according to an embodiment of the invention;

FIG. 4 illustrates a flow chart of partial details of an error proof method for recording according to an embodiment of the invention;

FIG. 5 illustrates a flow chart of partial details of an error proof method for recording according to an embodiment of the invention; and

FIG. 6 illustrates a flow chart of partial details of an error proof method for recording according to an embodiment of the invention.

### DETAILED DESCRIPTION

The spirit of the invention is disclosed hereafter with reference to the drawings and detailed description. After learning the preferred embodiments of the invention, those of skills in the art can make modifications and variations based on the technology taught in the invention, without departing from the spirit and scope of the invention.

An aspect of the invention provides a recording device which is connected to a set-top box. The recording device analyzes a video signal of the set-top box by image identification technique and analyzes an audio signal to determine the status of the set-top box and record an expected television program correctly for users. In the following embodiments of the invention, the recording devices can be computers, mobile phones, tablet computers, embedded systems or other electronic devices with an image processing function.

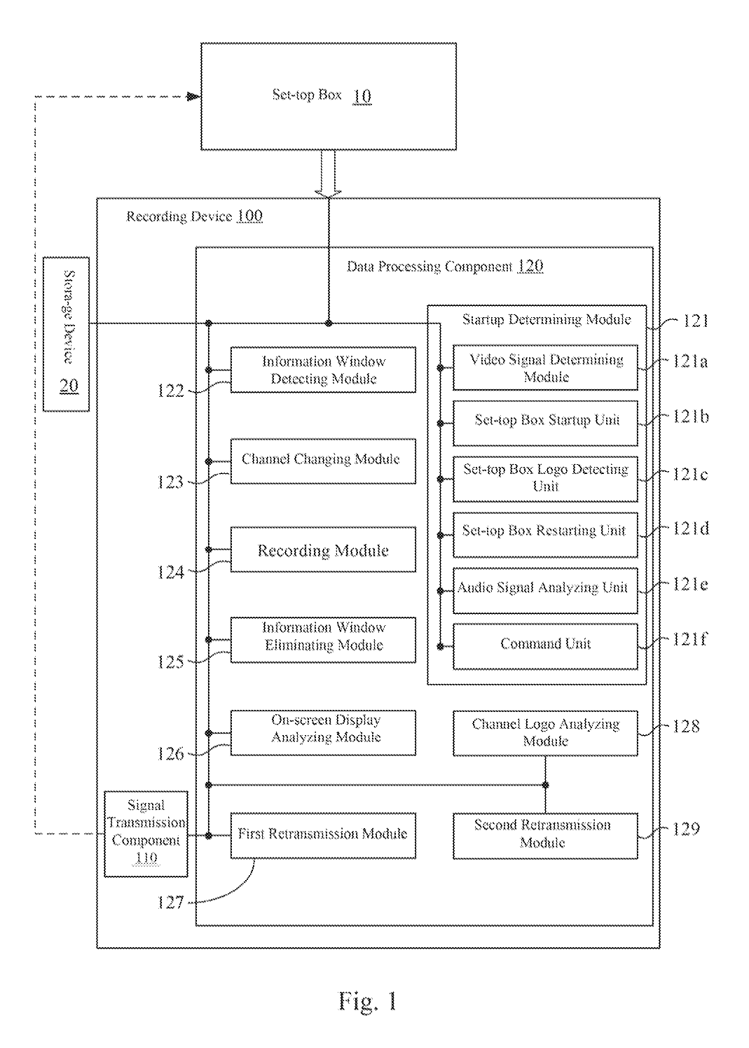

FIG. 1 illustrates a block diagram of a recording device 100 according to an embodiment of the invention. The recording device 100 is connected to a set-top box 10, including a signal transmission component 110 and a data processing component 120. The signal transmission component 110 is used to transmit a command to the set-top box 10, and may be an infrared signal transmitter, a Bluetooth signal transmitter or other wired or wireless signal transmitter. The data processing component 120 is used to receive a signal from the set-top box 10 and determine whether to command the set-top box 10 to perform operations such as startup, channel changing or recording according to the signal from the set-top box 10. The data processing component 120 can be implemented by software, or a software/hardware co-design circuit.

The data processing component 120 may include a startup determining module 121, an information window detecting module 122, a channel changing module 123 and a recording module 124.

The startup determining module 121 is used to determine whether the startup process of the set-top box 10 has been finished according to the video signal and the audio signal outputted from the set-top box 10. For example, if the voice and image of the video signal and the audio signal are different from those of the television program, then the startup determining module 121 determines that the startup process of the set-top box 10 has not been finished. For example, the startup determining module 121 can determine whether the voice and image is the same as those of the television program according to whether the video signal and the audio signal are changing dynamically. The information window detecting module 122 is used to analyze the video signal outputted from the set-top box 10 by the image identification technique to determine whether the image of the video signal is covered by the information window after the startup process of the set-top box 10 is finished. For example, when an unchanged region exists on the image of the video signal, the information window detecting module 122 can determine that this unchanged region is the information window. The information window mentioned herein may be an advertisement, a system status message or an operation menu, etc. The channel changing module 123 is used to command the signal transmission component 110 to transmit the channel changing signal to change the channel of the set-top box 10 to the reserved recording channel when the image of the video signal is not covered by any information window. The reserved recording channel mentioned herein is a specific channel for recording which is predetermined by a user. The recording module 124 is used to start a recording after the channel of the set-top box 10 is changed to the reserved recording channel and store the recorded content in a storage device 20. The storage device 20 may be an external or internal storage medium. For example, the storage device 20 may be but not limited to a hard disk, a flash drive or a memory card.

Through the cooperatively operation of the above-mentioned modules, it can be avoided that the recording device 100 transmits a command to the set-top box 10 when the startup process of the set-top box 10 has not been finished or the image of the video signal is covered by the information window. Accordingly, the recording device 100 is avoided to record the wrong image or television program as the command cannot be executed.

In this embodiment, the data processing component 120 further includes an information window eliminating module 125. The information window eliminating module 125 is used to command the signal transmission component 110 to transmit the information window eliminating signal to eliminate the information window covering the image. Through the information window eliminating module 125, the recording device 100 can eliminate the information window when the image of the video signal is covered by the information window so as to avoid that the recording device 100 records the wrong image as the set-top box 10 cannot execute the command transmitted by the signal transmission component 110.

In this embodiment, the startup determining module 121 may include a video signal determining unit 121a and a set-top box startup unit 121b. The video signal determining unit 121a is used to determine whether the set-top box 10 outputs the video signal. For example, the video signal determining unit 121a can make use of a signal processing circuit to amplify the video signal outputted from the set-top box 10. Then the video signal determining unit 121a analyzes whether horizontal and vertical synchronous signals of the video signal continuously exist within a certain time period (e.g., within 3 seconds) to determine whether the set-top box 10 outputs the video signal. The set-top box startup unit 121b is used to command the signal transmission component 110 to transmit the power source signal to start the set-top box 10 when the set-top box 10 does not output the video signal.

Through the above-mentioned modules, it can be avoided that the set-top box 10 is started or closed incorrectly as the recording device 100 transmits the power source signal aimlessly.

In this embodiment, the startup determining module 121 further includes a set-top box logo detecting unit 121c and a set-top box restarting unit 121d. The set-top box logo detecting unit 121c is used to analyze whether the image of the video signal outputted from the set-top box 10 includes the set-top box logo of the set-top box 10 by the image identification technique after the signal transmission component 110 transmits the power source signal to the set-top box 10. The set-top box logo mentioned herein is a logo which is used to identify different species of set-top boxes. Such a set-top box logo appears in the startup images of some set-top boxes, e.g., the multimedia on demand (MOD) set-top box of Chunghwa Telecom. Accordingly, for these set-top boxes, it can be determined that whether the set-top box is started successfully according to whether a set-top box logo appears. Additionally, the set-top box restarting unit 121d is used to command the set-top box startup unit 121b to restart the set-top box 10 after the set-top box logo detecting unit 121c determines that the image of the video signal does not include the set-top box logo of the set-top box 10, i.e., the set-top box 10 is not started normally.

In this embodiment, the startup determining module 121 further includes an audio signal analyzing unit 121e and a command unit 121f. The audio signal analyzing unit 121e is used to determine whether the set-top box 10 outputs the audio signal. For example, the audio signal analyzing unit 121e can determine whether this audio signal is mute according to whether the digital data quantity of the audio signal exceeds a predetermined threshold within a certain time period. If the set-top box 10 has outputted the video signal and the audio signal, then it means that the startup process of the set-top box 10 is finished. If the set-top box 10 outputs the video signal while it does not output the audio signal, then it is possible that the set-top box 10 is still in the startup process or the set-top box 10 displays the startup menu or the system status messages. Accordingly, the command unit 121f is used to command the information window detecting module 122 to determine whether the image of the video signal is covered by the information window when the set-top box 10 outputs the video signal while it does not output the audio signal. If the image of the video signal is covered by the information window, it means that the video signal outputted from the set-top box 10 may display the startup menu or the system information notification. Then the information window eliminating module 125 can be notified to eliminate the information window covering the image.

In this embodiment, the data processing component 120 further includes an on-screen display (OSD) analyzing module 126 and a first retransmission module 127. The on-screen display analyzing module 126 is used to analyze the on-screen display on the image of the video signal by the image identification method to determine whether the channel changing signal is received correctly. The on-screen display mentioned herein is a corresponding channel number on the image of the video signal outputted from the set-top box 10 when the signal transmission component 110 is transmitting the channel changing signal. For example, when the signal transmission component 110 transmits the channel changing signal to change the channel to channel 55, the image of the video signal displays the number 55. By determining whether the on-screen display is consistent with the reserved recording channel, it can be avoided that the channel of the set-top box 10 is changed to a wrong channel as the channel changing signal is received incorrectly. Additionally, the first retransmission module 127 is used to command the signal transmission component 110 to retransmit the channel changing signal to change the channel of the set-top box 10 to the reserved recording channel when the channel changing signal is received incorrectly.

In this embodiment, the data processing component 120 further includes a channel logo analyzing module 128 and a second retransmission module 129. The channel logo analyzing module 128 is used to analyze the channel logo on the image of the video signal by the image identification method to determine whether the changed channel of the set-top box 10 is the reserved recording channel after the channel of the set-top box 10 is changed. The channel logo mentioned herein is a graphic and/or text logo used by the TV station of each channel for identification. For example, the channel logo can be a graphic and/or text logo of TTV, CTV, CTS, HBO and other TV stations. The second retransmission module 129 is used to command the signal transmission component 110 to retransmit the channel changing signal to change the channel of the set-top box 10 to the reserved recording channel when the channel logo of the changed channel of the set-top box 10 is different from that of the reserved recording channel.

It should be noted that the operation methods for various set-top boxes can be pre-stored in the recording device 100. After a user specifies which kind of set-top box to be recorded, the data processing component 120 knows how to make the signal transmission component 110 transmit a command to operate the set-top box. For example, the operation method can be but not limited to various infrared codes which control the set-top box.

Additionally, those of skills in the art should understand that all the above-mentioned functions of each module can be implemented by a central processor (or a microprocessor) and a digital signal processor (DSP) combined with some hardware circuits. The central processor or microprocessor is responsible for transmitting a command to the digital signal processor to make the digital signal processor analyze the image or voice and return the analysis result to the central processor or microprocessor. Then the central processor or microprocessor performs the next operation according to the analysis result. For example, the functions of the above-mentioned information window detecting module 122, the video signal determining unit 121a, the set-top box logo detecting unit 121c, the audio signal analyzing unit 121e, the on-screen display analyzing module 126 and the channel logo analyzing module 128 can be implemented by DSP. The functions of the above-mentioned channel changing module 123, the recording module 124, the information window eliminating module 125, the set-top box startup unit 121b, the set-top box restarting unit 121d, the command unit 121f, the first retransmission module 127 and the second retransmission module 129 can be implemented by the central processor or microprocessor. The functions of the startup determining module 121 can be implemented by the combination of DSP and the central processor or microprocessor. However, it should be noted that the functions of each module and unit also can be implemented only by the central processor or microprocessor or by other devices or circuits with the similar capabilities, and is not limited to the above-mentioned examples.

Furthermore, in some embodiments, the above-mentioned first retransmission module 127, the second retransmission module 129 and the channel changing module 123 can be integrated into one or two modules or units. In some other embodiments, the set-top box startup unit 121b, the set-top box restarting unit 121d and the command unit 121f also can be integrated into one or two modules or units.

Another aspect of the invention provides an error proof method for recording which can be applied to a recording device to help the recording device record an expected television program correctly for users. The error proof method for recording can be implemented by means of procedures. The procedures can be stored in computers, mobile phones, tablet computers and other electronic devices or can be stored in a storage media of embedded systems. Through these devices, the procedures in the storage media can be read for implementation. The storage media can be memories, hard disks, optical disks, network databases and other storage media which can be easily thought of by those of skills in the art and have the same functions.

In the following embodiments of the invention, the error proof method for recording is applied to the recording device, and the recording device is connected to a set-top box.

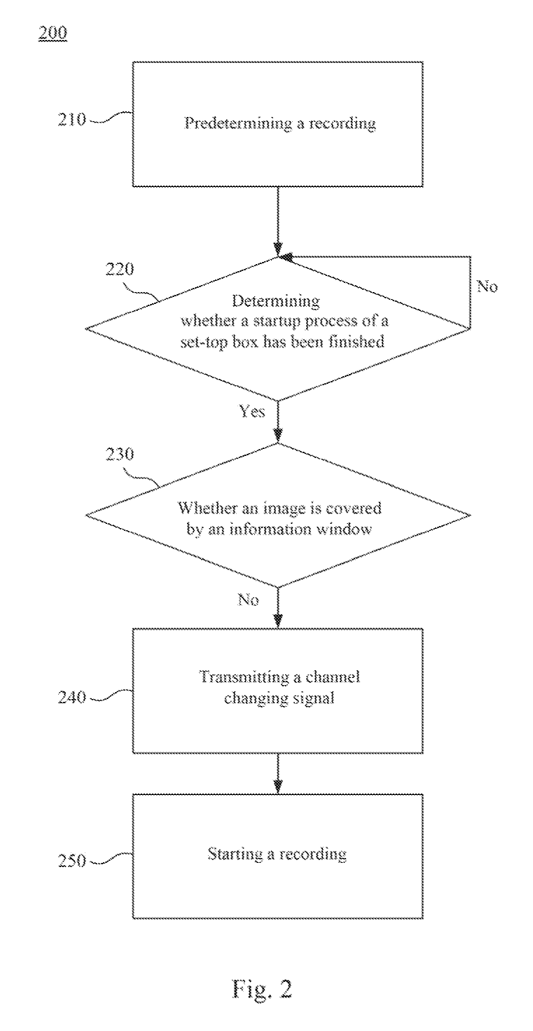

FIG. 2 illustrates a flow chart of an error proof method for recording 200 according to an embodiment of the invention. The error proof method for recording 200 includes steps 210-250. In the step 210, when a recording time predetermined by a user is reached, an error proof procedure for recording is started.

Firstly, the recording device performs the step 220, i.e., analyzing a video signal and an audio signal outputted from a set-top box so as to determine whether a startup process of the set-top box has been finished according to whether the video signal and the audio signal are the normal program image or voice. If the startup process of the set-top box has not been finished, then the recording device repeats the step 220, until the startup process of the set-top box is finished. In this way, it can be avoided that the set-top box receives the command incorrectly or the set-top box cannot receive the command as the recording device transmits a command to the set-top box when the startup process of the set-top box has not been finished.

After the startup process of the set-top box is finished, the recording device performs the step 230, i.e., analyzing the video signal outputted from the set-top box to determine whether an image of the video signal is covered by an information window. The information window mentioned herein refers to a stationary window which appears automatically and covers the image, which can be an advertisement, a system notification or a user menu, etc. If the image of the video signal is not covered by any information window, then the recording device performs the step 240, i.e., commanding a signal transmission component to transmit a channel changing signal to change a channel of the set-top box to a reserved recording channel. The reserved recording channel mentioned herein is a specific channel which is predetermined by a user for recording. The signal transmission component may be an infrared signal transmitter, a bluetooth signal transmitter or other wired or wireless signal transmitter internally installed in the recording device or externally connected to the recording device.

Finally, after the channel of the set-top box is changed to the reserved recording channel, the recording device performs the step 250, i.e., starting a recording. The recorded content can be stored in a storage device, such as but not limited to a hard disk, a flash drive or a memory card.

Through the above-mentioned steps 210-250 performed by the recording device, it can be avoided that the recording device 100 transmits a command to the set-top box 10 when the startup process of the set-top box 10 has not been finished or the image of the video signal is covered by the information window, such that the command cannot be executed and as a result that the recording device record the wrong image or television program.

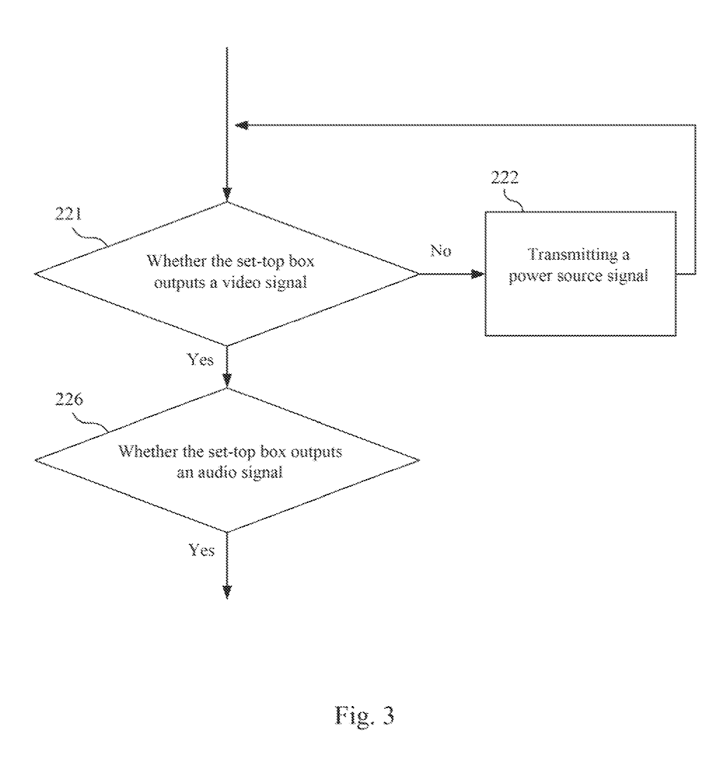

In this embodiment, the step 220 may include the sub-steps 221 and 222, as shown in FIG. 3.

In the sub-step 221, the recording device determines whether the video signal outputted from the set-top box is received. If the video signal outputted from the set-top box is not received or the video signal is only a noise, then it means that the set-top box is not started, and thus the recording device performs the sub-step 222. In the sub-step 222, the recording device commands the signal transmission component to transmit a power source signal to start the set-top box. Then the recording device repeats the sub-step 221, determining whether the set-top box outputs the video signal, In this way, it can be avoided that the set-top box is started or closed incorrectly as the recording device transmits the power source signal aimlessly.

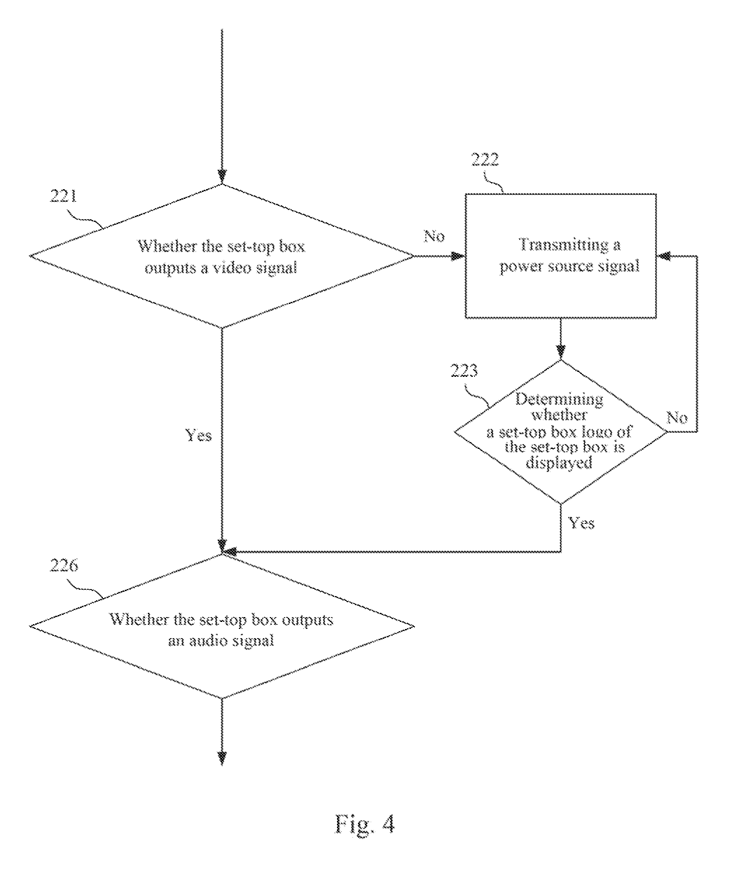

Additionally, as shown in FIG. 4, in this embodiment, the step 220 may further include the sub-step 223. The sub-step 223 is performed after the sub-step 222. In the sub-step 223, after the signal transmission component is commanded to transmit the power source signal, the recoding device analyzes whether the image of the video signal outputted from the set-top box includes a set-top box logo of the set-top box by the image identification technique. The set-top box logo mentioned herein is a logo which is used to identify different species of set-top boxes. Such a set-top box logo appears in the startup images of some set-top boxes. Accordingly, in these set-top boxes, the recording device can determine whether the set-top box is started successfully according to whether the set-top box logo appears. If the image of the video signal does not include the set-top box logo of the set-top box, i.e., when the set-top box is not started normally, then the recording device performs the sub-step 222, retransmitting the power source signal.

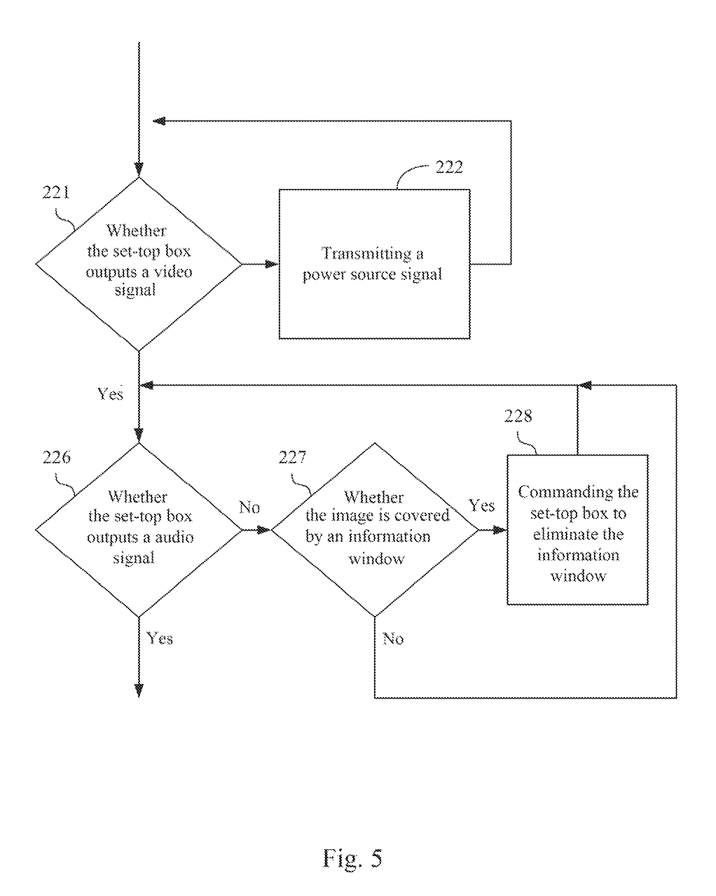

In some other embodiments, the step 220 may further include the sub-steps 226, 227 and 228, as shown in FIG. 5. In the sub-step 226, after the set-top box outputs the video signal, the recording device determines whether the set-top box outputs the audio signal. If the set-top box outputs the audio signal, it means that the startup process of the set-top box is finished. If the set-top box outputs the video signal while it does not output the audio signal, then it is possible that the set-top box is still in the startup process or the set-top box displays the startup menu or the system status message. At this time, the recording device performs the sub-step 227, determining whether the image of the video signal is covered by the information window. If the image of the video signal is covered by the information window, then the recording device further performs the sub-step 228, commanding the signal transmission component to transmit an information window eliminating signal to command the set-top box to eliminate the information window. Afterwards, the recording device repeats the sub-step 226, determining whether the set-top box outputs the audio signal. Alternatively, if the image is not covered by the information window, the procedure of the recording device also returns to the sub-step 226, waiting for the set-top box to finish the startup process.

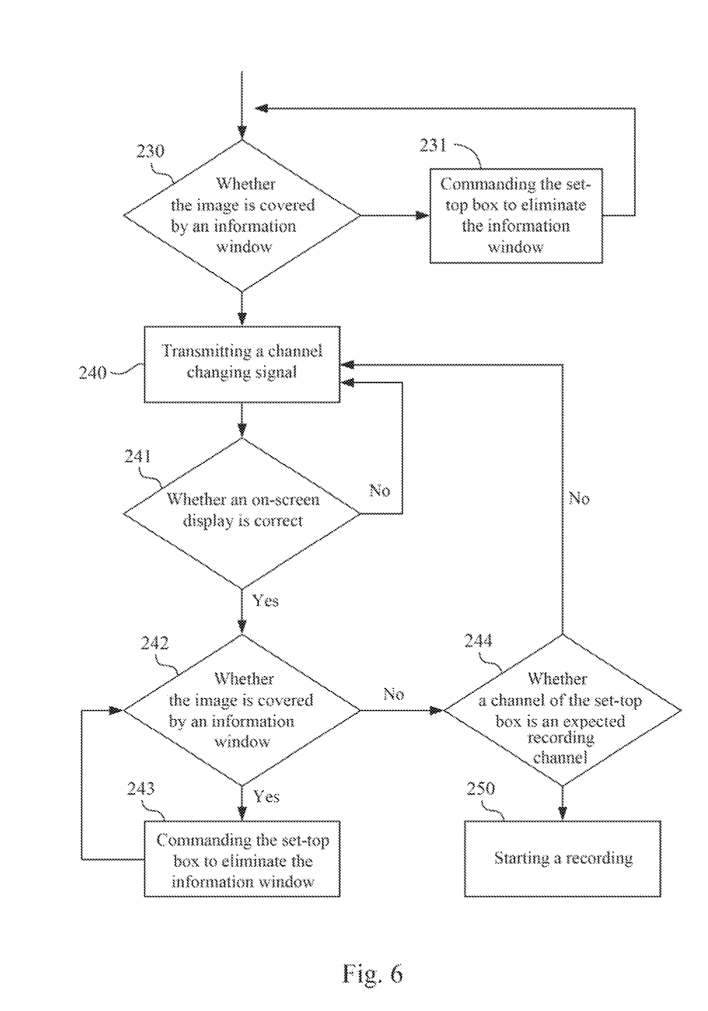

In some other embodiments, the error proof method for recording 100 further includes the step 231, as shown in FIG. 6. If in the step 230, the image of the video signal is covered by the information window, then the recording device performs the step 231, i.e., commanding the signal transmission component to transmit the information window eliminating signal to command the set-top box to eliminate the information window. In this way, it can be avoided that the set-top box cannot execute the command transmitted by the signal transmission component or the recording device records a wrong image.

In some other embodiments, in the step 240 after the signal transmission component transmits the channel changing signal, the recording device can further determine whether the channel of the set-top box is changed correctly, whether the image is normal after the channel is changed and/or whether the changed channel is the reserved recording channel by the image identification technique. Accordingly, the error proof method for recording 100 may further include the step 241, the step 242, the step 243 and the step 244. It should be stated in advance that the steps 241, 242, 243 and 244 all can be omitted in different embodiments depending on the actual needs. For example, after the recording device performs the step 241, the step 250 can be performed directly, or after the recording device performs the step 241, the step 244 can be performed subsequently. It is obvious that the step 241 also can be omitted in some embodiments. Accordingly, the steps included in the error proof method for recording 100 are not limited to those illustrated in FIG. 6.

After the channel changing signal is transmitted, the recording device performs the step 241, i.e., analyzing the on-screen display on the image of the video signal to determine whether the channel changing signal is received correctly. If the channel changing signal is received incorrectly, then the recording device repeats the step 240, commanding the signal transmission component to transmit the channel changing signal to change the channel of the set-top box to the reserved recording channel. The on-screen display mentioned herein is a corresponding channel number on the image of the video signal outputted from the set-top box when the signal transmission component is transmitting the channel changing signal.

After the channel of the set-top box is changed, the recording device performs the step 242, analyzing the video signal outputted from the set-top box to determine whether the image of the video signal is covered by the information window. If the image is covered by the information window, then the recording device performs the step 243, commanding the set-top box to eliminate the information window through the signal transmission component. After the channel of the set-top box is changed to the reserved recording channel, if the image of the video signal outputted from the set-top box is not covered by any information window, then a recording is started. By performing the step 242 and the step 243, it can be avoided that after the channel of the set-top box is changed to the reserved recording channel, the recording device records the information window on the image of the video signal incorrectly, such as the advertisement information or the system notification information.

After the channel of the set-top box is changed, the recording device performs the step 244, analyzing the channel logo on the image of the video signal to determine whether the changed channel of the set-top box is the reserved recording channel. If the channel logo of the changed channel of the set-top box is different from that of the reserved recording channel, then the recording device repeats the step 240, commanding the signal transmission component to retransmit the channel changing signal to change the channel of the set-top box to the reserved recording channel. The channel logo mentioned herein is a graphic and/or text logo used by the TV station of each channel for identification. For example, the channel logo can be a graphic and/or text logo of TTV, CTV, CTS, HBO and other TV stations.

The error proof method for recording 100 can be applied to the recording device 100 of the embodiment as illustrated in FIG. 1. The implementing detail is similar to that of the embodiment, and thus it is not illustrated here any further. However, it should be noted that the error proof method for recording 100 also can be applied to other different recording devices and it is not limited to the above-mentioned embodiments.

By applying the above-mentioned embodiments, it can be determined that whether the startup process of the set-top box has been finished, whether the image outputted from the set-top box is covered by the information window and whether the channel of the set-top box is changed to the reserved recording channel. Corresponding actions are made automatically by the recording device through these determinations, so as to make the recording device record the expected television program correctly for users.

Although the invention has been disclosed with reference to the above embodiments, these embodiments are not intended to limit the invention. It will be apparent to those of skills in the art that various modifications and variations can be made without departing from the spirit and scope of the invention. Therefore, the scope of the invention shall be defined by the appended claims.

1. An error proof method for recording, applied to a recording device, wherein the recording device is connected to a set-top box and the error proof method for recording comprises:
determining, through the recording device, whether a startup process of the set-top box has been finished according to a video signal and an audio signal outputted from the set-top box;
analyzing, through the recording device, the video signal outputted from the set-top box to determine whether an image of the video signal is covered by an information window after the startup process of the set-top box is finished;
commanding, through the recording device, a signal transmission component to transmit a channel changing signal to change a channel of the set-top box to a reserved recording channel when the image of the video signal is not covered by any information window; and
starting, through the recording device, a recording after the channel of the set-top box is changed to the reserved recording channel and storing the recorded content in a storage device.

2. The error proof method for recording of claim 1, wherein the step of determining whether the startup process of the set-top box has been finished comprises:
determining whether the video signal outputted from the set-top box is received, and
commanding the signal transmission component to transmit a power source signal to start the set-top box when the video signal outputted from the set-top box is not received.

3. The error proof method for recording of claim 2, wherein the step of determining whether the startup process of the set-top box has been finished further comprises:
analyzing whether the image of the video signal outputted from the set-top box comprises a set-top box logo of the set-top box after transmitting the power source signal to the set-top box; and
determining that the startup of the set-top box is failed when the image of the video signal does not comprise the set-top box logo of the set-top box and commanding the signal transmission component to restart the set-top box.

4. The error proof method for recording of claim 2, wherein the step of determining whether the startup process of the set-top box has been finished further comprises:
determining whether the audio signal outputted from the set-top box is received,
determining whether the image of the video signal is covered by another information window when the video signal is received while the audio signal is not received; and
commanding the signal transmission component to transmit an information window eliminating signal to command the set-top box to eliminate the information window when the image of the video signal is covered by the another information window.

5. The error proof method for recording of claim 1, further comprising:
commanding the signal transmission component to transmit an information window eliminating signal to command the set-top box to eliminate the information window when the image of the video signal is covered by the information window.

6. The error proof method for recording of claim 1, further comprising:
analyzing the video signal outputted from the set-top box to determine whether the image of the video signal is covered by another information window when the channel of the set-top box is changed to the reserved recording channel; and
commanding the signal transmission component to transmit an information window eliminating signal to command the set-top box to eliminate the information window when the image of the video signal is covered by the another information window.

7. The error proof method for recording of claim 1, further comprising:
analyzing an on-screen display (OSD) on the image of the video signal to determine whether the channel changing signal is received correctly; and
commanding the signal transmission component to retransmit the channel changing signal to change the channel of the set-top box to the reserved recording channel when the channel changing signal is received incorrectly.

8. The error proof method for recording of claim 1, further comprising:
analyzing a channel logo on the image of the video signal to determine whether the changed channel of the set-top box is the reserved recording channel after the channel of the set-top box is changed; and
commanding the signal transmission component to retransmit the channel changing signal to change the channel of the set-top box to the reserved recording channel when the channel logo of the changed channel of the set-top box is different from that of the reserved recording channel.

9. A recording device, comprising:
a signal transmission component; and
a processor comprising: a data processing component, wherein the data processing component comprises:
a startup determining module, for determining whether a startup process of a set-top box has been finished according to a video signal and an audio signal outputted from the set-top box;
an information window detecting module, for analyzing the video signal outputted from the set-top box to determine whether an image of the video signal is covered by an information window after the startup process of the set-top box is finished;
a channel changing module, for commanding the signal transmission component to transmit a channel changing signal to change a channel of the set-top box to a reserved recording channel when the image of the video signal is not covered by any information window; and
a recording module, for starting a recording after the channel of the set-top box is changed to the reserved recording channel and storing the recorded content in a storage device.

10. The recording device of claim 9, wherein the data processing component further comprises:
an information window eliminating module, for commanding the signal transmission component to transmit an information window eliminating signal to eliminate the information window covering the image.

11. The recording device of claim 10, wherein the startup determining module comprises:
a video signal determining unit, for determining whether the set-top box outputs the video signal; and
a set-top box startup unit, for commanding the signal transmission component to transmit a power source signal to start the set-top box when the set-top box does not output the video signal.

12. The recording device of claim 11, wherein the startup determining module further comprises:
a set-top box logo detecting unit, for analyzing whether the image of the video signal outputted from the set-top box comprises a set-top box logo of the set-top box after the signal transmission component transmits the power source signal to the set-top box; and
a set-top box restarting unit, for commanding the set-top box startup unit to restart the set-top box after the set-top box logo detecting unit determines that the image of the video signal does not comprise the set-top box logo of the set-top box.

13. The recording device of claim 11, wherein the startup determining module further comprises:
an audio signal analyzing unit, for determining whether the set-top box outputs the audio signal; and
a command unit, for commanding the information window detecting module to determine whether the image of the video signal is covered by another information window when the set-top box outputs the video signal while it does not output the audio signal, and notifying the information window eliminating module to eliminate the another information window covering the image when the image of the video signal is covered by the another information window.

14. The recording device of claim 10, wherein the data processing component further comprises:
an on-screen display analyzing module, for analyzing an on-screen display on the image of the video signal to determine whether the channel changing signal is received correctly; and
a first retransmission module, for commanding the signal transmission component to retransmit the channel changing signal to change the channel of the set-top box to the reserved recording channel when the channel changing signal is received incorrectly.

15. The recording device of claim 10, wherein the data processing component further comprises:
a channel logo analyzing module, for analyzing a channel logo on the image of the video signal to determine whether the changed channel of the set-top box is the reserved recording channel after the channel of the set-top box is changed; and
a second retransmission module, for commanding the signal transmission component to retransmit the channel changing signal to change the channel of the set-top box to the reserved recording channel when the channel logo of the changed channel of the set-top box is different from that of the reserved recording channel.
